(19) United States
(12) Patent Application Publication
(10) Pub. No.: US 2018/0064253 A1
(43) Pub. Date: Mar. 8, 2018

(54) SPINE SUPPORT INSERT FOR ADJUSTABLE CUSHION DEVICE

(71) Applicant: Enduring Wellness, LLC, Cleveland, OH (US)

(72) Inventors: Anthony DeMore, Willoughby, OH (US); Brian Sokol, Vermilion, OH (US); Rene Polin, Highland Heights, OH (US); Jason Cooper, Newton, MA (US); Carla Macklin, Shaker Heights, OH (US)

(21) Appl. No.: 15/793,446

(22) Filed: Oct. 25, 2017

Related U.S. Application Data
(63) Continuation-in-part of application No. 15/492,347, filed on Apr. 20, 2017.
(60) Provisional application No. 62/325,075, filed on Apr. 20, 2016.
(60) Provisional application No. 62/527,176, filed on Jun. 30, 2017.

(51) Int. Cl. A47C 7/42; A47G 9/10

(52) U.S. Cl. CPC A47C 7/425; A61G 5/1091; A47G 2009/1018; A47G 9/10

(57) ABSTRACT

This disclosure relates to a cushion and more particularly to a pillow having a hollow compartment in which a cervical spine support can be disposed therein. The cervical spine support can comprise two or more segments having different densities or geometries. The cervical spine support can be rotated so as to provide a user with different levels of firmness while resting. The cervical spine support can also include functional components designed to increase user comfort.

### CROSS-REFERENCE TO RELATED APPLICATIONS

This application claims priority as a continuation-in-part of U.S. patent application Ser. No. 15/492,347, filed on Apr. 20, 2017, and entitled “ADJUSTABLE CUSHION DEVICE”, which in turn claims priority to U.S. Provisional Patent Application No. 62/325,075, filed on Apr. 20, 2016, and entitled “ADJUSTABLE CUSHION DEVICE”, the entirety of each of these is incorporated herein by reference. This application also claims priority to U.S. Provisional Patent Application No. 62/527,176, filed on Jun. 30, 2017, and entitled “PILLOW CASE FOR CUSHION DEVICE”, the entirety of which is also incorporated herein by reference.

### FIELD

The present disclosure relates to a cushion and more particularly to a spine support insert that can be disposed in the cushion.

### BACKGROUND

Various devices exist that are intended for use in aligning the cervical spine. For example, McKenzie rolls that can be placed under or inside conventional pillows are prescribed to aid in alignment of the cervical spine. However, since physicians often do not know what type of pillow a McKenzie roll will be placed under, or in, dimensions of a prescribed McKenzie roll may be poorly suited to cervical spine alignment of an individual patient. There are multiple pillows in the marketplace that claim to align the cervical spine. But because of the variabilities in end-user physiology, material selections, sleep position preference, mattress firmness, and personal comfort preferences, no one pillow exists that offers true customization to solve the problem of cervical spine alignment for a wide range of consumers. Furthermore, it is also understood that factors beyond pillow softness and texture can affect sleep quality of a user when using a pillow. For example, temperature, odors, and sounds can all influence the quality of a user's sleep.

It is well known that pillow cases provide numerous advantages to end-users of pillows. One advantage of using a pillow with a pillow case is that the surface of the pillow can be protected from various oils produced by the human body, specifically, the human head and hair, thus providing a cleaner and more hygienic surface for a user to rest his/her head. Additionally, unlike most pillows, a pillow case can be washed from time to time. Another advantage is that a pillow case can be made of a material that is more comfortable for contact with human skin than the material from which the pillow is produced. Yet another advantage is that a pillow case may provide a more aesthetically pleasing appearance to the pillow.

Certain pillows designed for aligning the cervical spine feature a head well, that is, a recessed portion of the pillow designed to accommodate a user's head. A head well aids in aligning the cervical spine while sleeping by allowing the head to be placed in an optimal position for cervical contour. Despite the availability of pillows including a head well and the advantages of using a pillow with a pillow case, pillow cases have not been developed to adequately accommodate a head well in a pillow. This leads to a problem referred to as “hammocking,” wherein a pillow case does not stretch to contact a bottom surface of the head well of a pillow such that empty space remains between the pillow case and the bottom surface of the head well, leading the pillow case to “hammock” between sides of the head well. This prevents the full benefits of the head well from being realized as the head never reaches a position optimal for cervical contour.

Thus, current pillows designed to align the cervical spine have several problems which hinder their effectiveness. First, current cervical spine aligning pillows lack customization options that can account for the wide variety of user comfort preferences. Second, current cervical aligning pillows fail to account for user comfort preferences other than pillow softness and/or pillow texture. Third, current pillows featuring head wells may encounter the hammocking problem described above when used with conventional pillow cases.

### SUMMARY

The following is a brief summary of subject matter that is described in greater detail herein. This summary is not intended to be limiting as to the scope of the claims.

The present disclosure relates to a cushion and more particularly to a pillow providing cervical alignment by way of a cervical spine support that is positioned along a major axis of the pillow, and that can be rotated around the major axis. The pillow includes a head well portion having a lower surface with a depth of 0.8 to 2.7 inches from a top surface of the pillow to further aid in cervical alignment by allowing a user's head to be placed in an optimal position for cervical counter. The pillow has a total thickness of 5 to 6.25 inches from a top surface of the pillow to a bottom surface of the pillow. The pillow may be rectangular and may have a length of 20 to 24 inches and a width of 11 to 16 inches. The pillow further includes a substantially hollow compartment in which the adjustable cervical spine support can be disposed therein. A circumferential difference between the cervical spine support and a surface of the hollow cavity can be from 1 μm to 1 cm.

The pillow can be disposed in a hollow cavity of a pillow case comprising a front portion comprising a front portion and a back portion, the front portion further comprising a central region and a non-central region. The central region is made of a single layer of a 4-way stretch material and the non-central region and the back portion are made of a non-stretchable material. The non-stretchable material may be porous. The front portion and the back portion are attached perimetrically and define the hollow cavity. The central region of the pillow case is aligned with the head well portion of the pillow. When a user's head rests on the central region of the pillow case, the central region stretches to contact the lower surface of the head well portion.

The cervical spine support may comprise a first segment made of a first material having a first density and a second segment made of a second material having a second density. The first segment and the second segment may have different geometries. The cervical spine support can be adjusted such that the different segments are positioned adjacent to the cervical spine of the user, thus providing different levels of firmness. The cervical spine support is disposed in the substantially hollow compartment of the pillow and runs along a major axis of the pillow. In an embodiment, the length of the cervical spine support can be 20 to 28 inches. In an embodiment, the cervical spine support is cylindrical and has a diameter of 3 to 6 inches.

The adjustable cervical spine support can be outfitted with different functional components designed to increase user comfort. In an embodiment, the functional component is a speaker embedded in the cervical spine support. The speaker may be configured to emit sounds conducive to user relaxation. In another embodiment, the functional component is a motor embedded in the cervical spine support coupled to at least one massage node. The motor can cause the at least one massage node to rotate or vibrate, thus providing a massage to a user while he or she lays on the pillow. In yet another embodiment, the functional component may be a porous or vented compartment embedded in or attached to the cervical spine support. A fragrant material may be disposed in the porous or vented compartment, thus providing a user with a pleasing olfactory sensation while using the pillow. In an additional embodiment, functional component may be a compartment embedded in or attached to the cervical spine support. A heat source may be disposed in the compartment to provide heat to the cervical spine area of a user. Alternatively, a pack filled with a gel or liquid may be disposed in the compartment, wherein the gel or liquid is chilled, such as being frozen prior to insertion into the pillow, thus providing cooling to the cervical spine area of a user.

In an embodiment, the functional component can be inserted into the second segment of the cervical spine support. In another embodiment, the functional component can be inserted into a cylindrical housing with a soft outer shell.

A cervical spine support for a pillow may be made by shaping a first segment from a first material to form a section of a cylinder. A second segment may be shaped from a second material, thereby forming a second section of a cylinder. The second segment may be shaped to have a different geometry than the first segment. The first segment and the second segment, and optionally, an additional segment, are then coupled to form the cylinder. A knob is then attached to an end of the cervical spine support. The length of the cervical spine support is 20 to 28 inches. Additionally, the cervical spine support is cylindrical and has a diameter of 3 to 6 inches. The cervical spine support is then inserted into a hollow compartment in the pillow.

The aforementioned pillow, adjustable cervical spine support, and pillow case system solves problems associated with current technologies relating to alignment of the cervical spine. First, the above-described system enables user-specific customization options that can account for the wide variety of user comfort preferences. Second, the system provides for additional features that take into account more than pillow firmness and texture. Third, the system solves the problem of “hammocking” by including a pillow case designed to stretch to dimensions of the pillow head well.

### BRIEF DESCRIPTION OF THE DRAWINGS

FIG. 1 is a perspective view of an example adjustable pillow.

FIG. 2 is a perspective, cut-away view of an example adjustable pillow, exposing a multi-density cervical spine support.

FIG. 3 is a cross-sectional view, along the major axis of an example multi-density cervical spine support in a flexed state.

FIG. 4 is a cross-sectional side view of the adjustable pillow.

FIG. 5 is a cross-sectional side view of an additional embodiment of an adjustable pillow.

FIG. 6 is a perspective view of an example adjustable cervical spine support.

FIG. 7A-C are views of another example adjustable cervical spine support.

FIG. 8A-D are side view diagrams of spinal alignment and misalignment.

FIG. 9 is a view of an embodiment of a pillow case including a central region made of a 4-way stretch material.

FIG. 10 is a view of a back portion of an embodiment of a pillow case including a central region made of a 4-way stretch material.

FIG. 11 is a cross-sectional side view of an embodiment of a pillow case including a central region made of a 4-way stretch material.

### DETAILED DESCRIPTION

Various technologies pertaining to a system comprising a pillow, cervical spine support, and pillow case are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

The present disclosure relates to a cushion and more particularly to a pillow providing cervical alignment by way of an adjustable cervical spine support structure that is positioned along a major axis of the pillow, and that can be rotated around the major axis. In an embodiment, the cervical spine support may also be fixed and not adjustable. The cervical spine support can comprise different segments having different properties designed to help a user sleep. The pillow also features a “head well,” that is, a depression in the surface of the pillow designed to accommodate a user's head. The pillow disclosed herein is further differentiated by its integration into a dimensionally correct pillow geometry and a platform that is specific to a back sleeper and a side sleeper.

The present disclosure also relates to a pillow case in which the pillow and cervical spine support can be disposed therein made of a 4-way stretch material and a non-stretch material. As used herein, the term “4-way stretch material” means a material that will stretch both crosswise and lengthwise from a rest position when pressure is applied (e.g., pressure from a human head resting on the material) and will revert to a rest position in the absence of pressure. The pillow case may be used with a pillow including a head well such that the central region of the pillow case is positioned next to the head well. When a user's head lays on the head well region of a pillow (covered by the pillow case), the central region stretches to come into contact with the head well, thus preventing “hammocking” of the pillow case. This enables a user of the pillow case to enjoy the therapeutic benefits of a pillow with a head well while retaining the hygienic, tactile, and aesthetic benefits of a traditional pillow case.

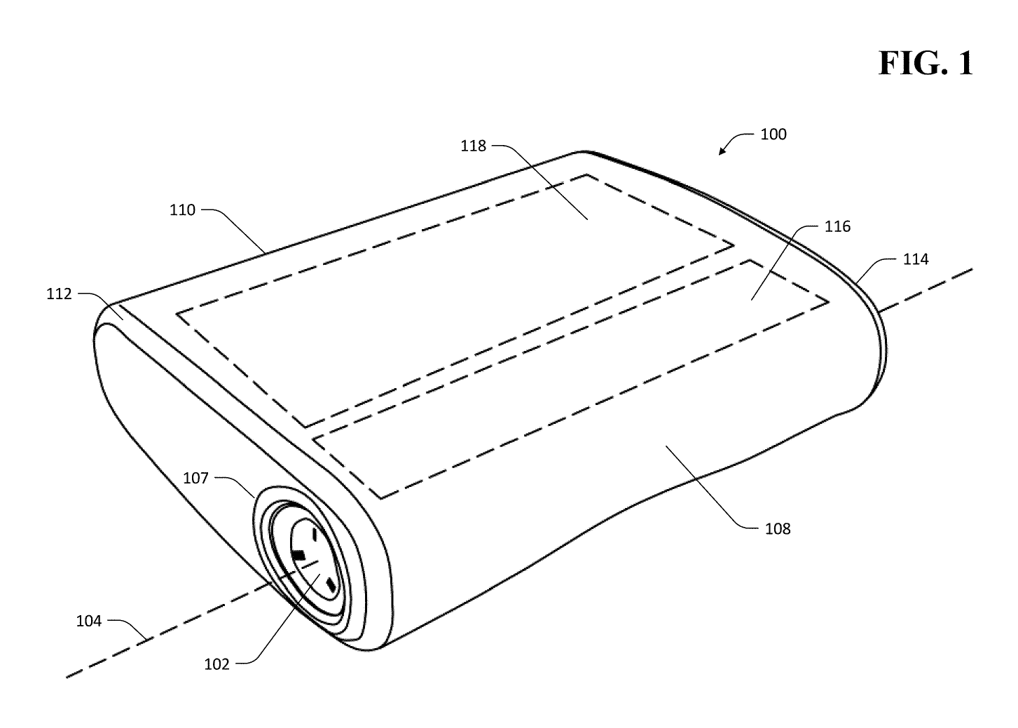

FIG. 1 shows an example adjustable pillow 100 with an adjustment knob 102 disposed along a major axis 104 of the pillow 100. The adjustment knob 102 is coupled to an adjustable cervical spine support 106 (not shown). The adjustment knob 102 can be used to adjust a firmness of at least a portion of the pillow 100 in order to aid in alignment of a user's cervical spine. In exemplary embodiments, the adjustment knob can comprise a soft yet stiff material, such as a foam or rubber material. The adjustment knob 102 can include a protruding center portion that can be grasped by a user in order to twist the knob 102 and thereby adjust the adjustable cervical spine support 106. The adjustable pillow 100 is designed to account for variabilities in end-user physiology, sleep position preference, mattress firmness, and personal comfort preferences. The pillow 100 is ergonomically shaped, e.g. with rounded ends 108, 110, and edges 112, 114.

In an embodiment, the pillow has a length of 20 to 24 inches and a width of 11 to 16 inches. For example, the pillow may have a length of 20.1 to 23.5 inches and a width of 11.5 to 15.5 inches, a length of 20.5 to 23 inches and a width of 12 to 14 inches, or a length of 21 to 22 inches and a width of 13 to 13.5 inches.

In an embodiment, the adjustable cervical spine support may have a length of 20 to 28 inches. For example, the adjustable cervical spine support may have a length of 20.5 to 27 inches, 21 to 26 inches, or 21.5 to 24 inches. In an embodiment, the adjustable cervical spine support may be cylindrical with a diameter of 3 to 6 inches. For example, the diameter of the adjustable cervical spine support may be 3.5 to 5.5 inches, 4 to 5 inches, or 4.2 to 4.8 inches.

In the embodiment of FIG. 1, the pillow 100 is ergonomically shaped for accommodating a user's neck being rested on a lower pillow surface 116, which is above the adjustable cervical spine support 106. The pillow 100 is also ergonomically configured to accommodate a user's skull to rest against an upper pillow surface 118. In this embodiment, the adjustable cervical spine support 106 and the major axis 104 is located offset from the center of the pillow toward the lower end 108 of the pillow 100 as depicted in FIG. 1. For example, the major axis 104 may be within 1.5 to 4 inches of the lower end of the pillow, such as 2 to 3.75 inches, or 2.5 to 3.5 inches.

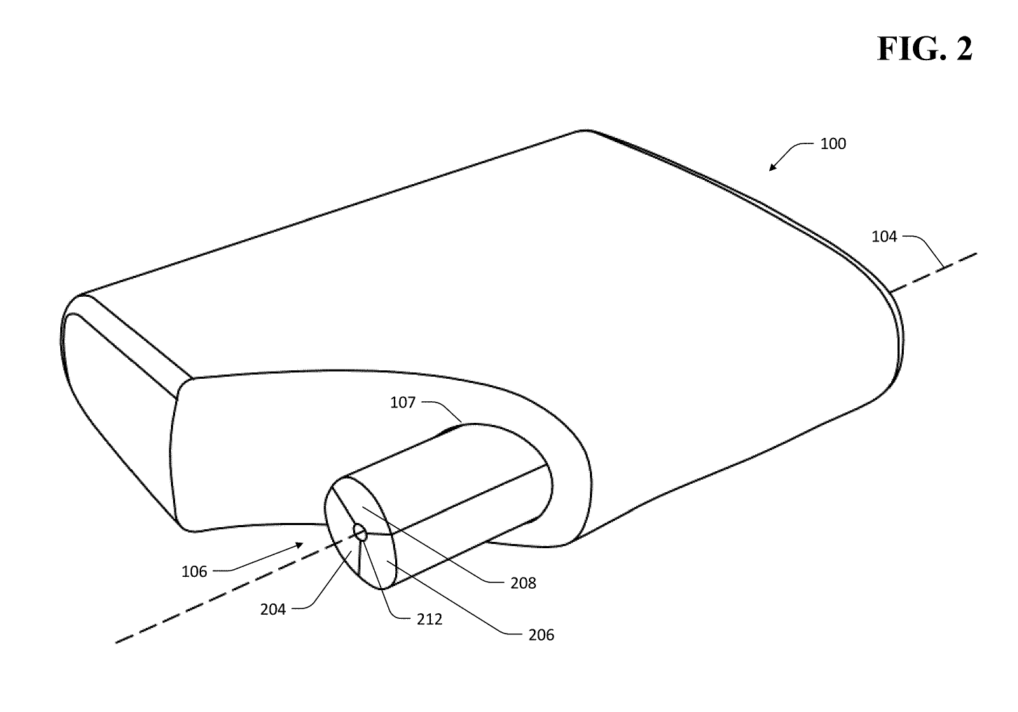

FIG. 2 shows details of the adjustable cervical spine support 106 in a cut-away view of the pillow 100. In this embodiment, the spine support 106 is a multi-density cervical spine support that is rotatable along the major axis 104 to expose three-segments 204, 206, 208 of material with different densities (e.g., soft 204, medium 206, or firm 208) in a position configured to be directly under the user's cervical spine. The three segments 204, 206, 208 run the entire length or substantially (e.g. 80%-99%, or 85% to 97%) the entire length of the pillow 100 and are coupled to the adjustment knob 102 (see FIG. 1) at one end. A second adjustment knob (not shown) may be present on the opposite side of the pillow 100 and is also coupled to the adjustable cervical spine support 106. At the center of the adjustable cervical spine support 106, a universal joint armature 212 runs along the major axis 104 of the adjustable cervical spine support 106 to allow for adjustability while providing flexibility on a variety of mattress densities. In some embodiments, a coupling that allows rotation of the cervical spine support 106 about the major axis 104 connects the universal joint armature 212 to the adjustment knob 102. The coupling may be attached to the pillow 100 and provides support to the universal joint armature 212 while allowing the cervical spine support 106 to be rotated. For example, the coupling can be rigid and fixed to the pillow 100 such that the coupling does not rotate, while the universal joint armature 212 protrudes through an opening in the coupling. The adjustment knob 102 can be attached to the portion of the universal joint armature 212 that protrudes through the opening in the fixed coupling, thereby allowing the cervical spine support 106 to be rotated by way of the adjustment 102.

It is considered that the multi-density segments 204, 206, 208 are also of varying hardness. For example, a first section differs by at least 10% in hardness from a second segment, and the second segment differs by at least 10% from a third segment. The recited differences in hardness may be 10% to 1000%, such as 20% to 500%, or 100% to 300%. Hardness or firmness may be measured by Indentation Load Deflection (ILD) (also known as Indentation Force Deflection, or IFD) which is determined by mechanical performance testing. In the ILD test, a material sample measuring 15″ by 15″ by 4″ is used and the force in pounds that it takes a 50 square inch circular indenter to compress the material 1 inch (25 percent of its thickness) is recorded. For example, if the sample requires 36 lbs. of pressure to indent it 1 inch, its ILD is 36. In an embodiment, the ILD of the segments of material 204, 206, 208, may be 8 to 100, for example, 12 to 70, or 20 to 60.

The material for the three segments and for the rest of the pillow may comprise memory foam, polyurethane foam, rubber, other types of particulate and non-particulate polymeric foam, latex, Talaly latex, natural latex, and synthetic latex, chopped foam, feathers, particulate material such as rubber, latex, Talaly latex, natural latex, and synthetic latex, or plastic beads, or natural filler material such as buckwheat husks. If particulate material or feathers are used, they would be contained in an appropriately shaped bag or other suitable container that does not interfere with the firmness of the material being felt from outside the container. In embodiments disclosed herein the material for the cervical spine support and the segments thereof is more firm than the surrounding pillow material. For example, the cervical spine support may comprise relatively firm non-viscoelastic foam, while the surrounding pillow, or at least the portion of the pillow above the cervical spine support, comprises a softer viscoelastic foam material.

In an embodiment, the adjustable cervical spine support 106 is configured to be in a cylindrical shape and fits within a hollow cylinder compartment 107 in the interior of the pillow 100. In an embodiment, sufficient clearance for the adjustable cervical spine support 106 to rotate within the cylindrical compartment is provided. This clearance may have a range, for example, 1 μm to 1 cm in circumferential difference, such as 10 μm to 1 mm, or 100 μtm to 5 mm. In another embodiment, there may be no clearance so long as the materials allow the adjustable cervical spine support 106 to rotate within the cylindrical compartment.

In other embodiments, either or both of the cervical spine support 106 or the hollow compartment can have irregularities in shape such that the cervical spine support 106 fits snugly within the hollow compartment when rotated to some positions and rotates freely when rotated to others. For example, the cervical spine support 106 can have protrusions and the hollow compartment can have indentations corresponding to the protrusions. When the cervical spine support 106 is rotated, the protrusions can make contact with the interior of the compartment, causing resistance due to friction, until the protrusions reach the indentations. When the protrusions of the cervical spine support 106 reach the indentations of the compartment as the cervical spine support 106 is rotated, the protrusions no longer make contact with the interior of the compartment. Thus, resistance to rotation of the cervical spine support 106 can be higher in some orientations of the cervical spine support 106 than others. This allows the cervical spine support 106 to rotate easily to one or more desired “settings” while keeping the cervical spine support 106 from rotating to another setting unless intentionally rotated by a user of the pillow 100. This may also affect the firmness of the pillow.

Additional embodiments of the adjustable cervical spine support 106 could have a minimum of two different density sections, and a maximum of four different density sections.

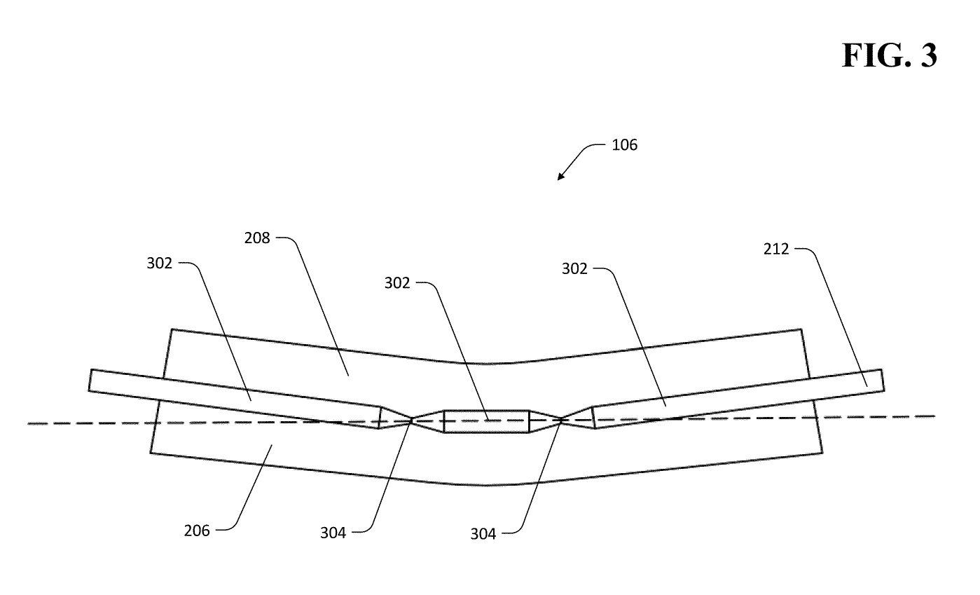

FIG. 3 shows a cross-sectional view of the adjustable cervical spine support 106 in a flexed state to simulate an in-use scenario accounting for the weight of the end-user's head and cervical spine, along with the give in a mattress. In this embodiment, the universal joint armature 212 consists of three rigid elements 302, connected by two flexible elements 304. The rigid material may be hard plastic, metal, or some other rigid material. The flexible elements may, for example, be u-joint couplings or thinner, i.e., narrowed portions of the same material as the rigid material. Additional embodiments of the universal joint armature could include additional flexible and/or rigid elements. The rigid and flexible elements should be configured to allow flexibility away from the major axis 104, but provide rigidity for rotation about the major axis 104. In an embodiment, the length of the central rigid element 302 is configured to be approximately the width a user's cervical spine, e.g., 2 to 5 inches, or 2.5 to 4.5 inches, or 3 to 4 inches.

The multi-density segments 204, 206, 208 are attached to the universal joint armature 212 by an adhesive or molding process. They may also be adhered or molded to each other at their respective surfaces running along the major axis 104.

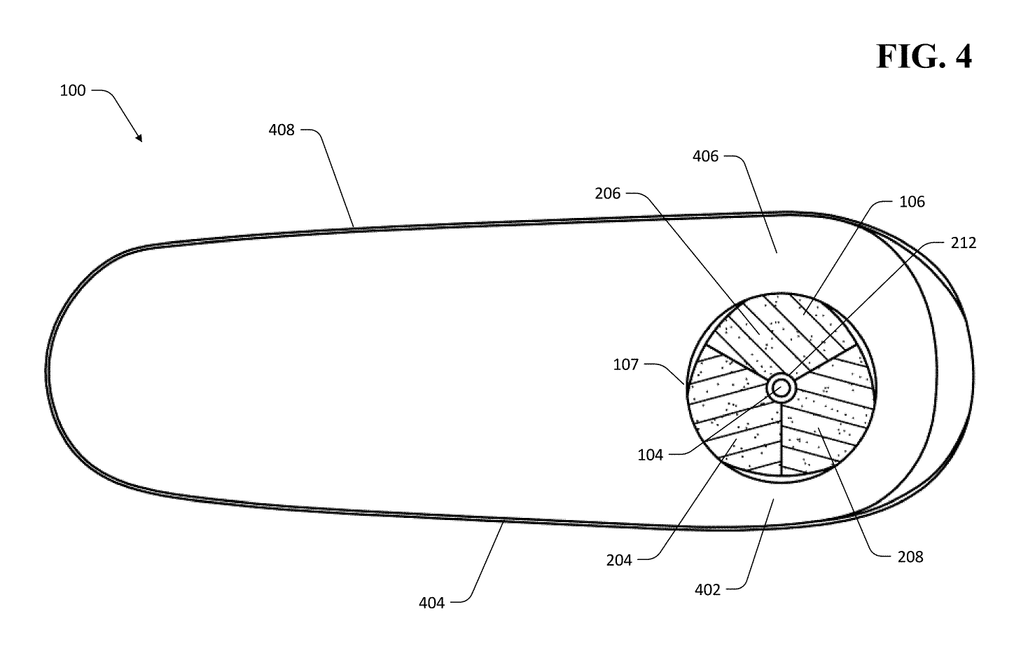

FIG. 4 shows a side view cross-section of an embodiment. This view shows the offset position of the adjustable cervical spine support 106 to create a thin section 402 on a bottom side 404 of the pillow 100, and a thicker section 406 on the top side 408 of the pillow 100, to create additional opportunities for comfort. In this embodiment, the major axis 104 is nearer a bottom side 404 of the pillow 100 than a top side 408 of the pillow 100, such as, for example the major axis 104 may be offset from the midpoint between the top and bottom sides 408, 404 of the pillow by 10% to 40% of the total thickness, such as 15% to 25% or 20% to 30%. This allows the user to further customize the pillow feel by putting their head on the top or the bottom side.

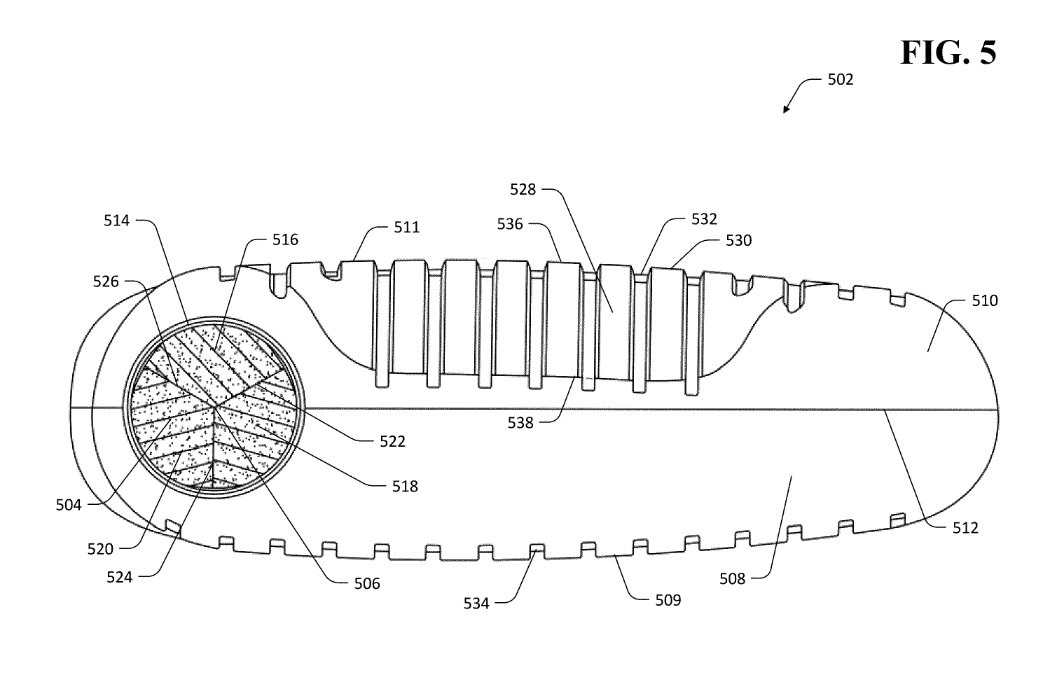

FIG. 5 shows a side view cross-section of another embodiment of an adjustable pillow 502 providing cervical alignment by way of a multi-density cervical spine support structure 504 that is positioned along a major axis 506 (extending into the page) of the pillow 502, and that can be rotated around the major axis 506. The pillow 502 comprises a lower section 508, having a lower surface 509, and an upper section 510, having an upper surface 511, wherein the lower section 508 and the upper section 510 are joined at an interface 512. In an example, the lower section 508 can be placed on a mattress or other surface for sleeping and a head of a user of the pillow 502 can rest on the upper section 510 when the pillow 502 is in use. In other embodiments, the lower section 508 and upper section 510 are integrally made, that is, they are manufactured as a single unit with a cavity for support structure 504.

In an example, the lower section 508 and the upper section 510 of the pillow 502 are joined at the interface 512 by a glue or other adhesive material. In an exemplary embodiment, when joined, the lower and upper sections 508, 510 can have a total height of between 4.5 and 6.25 inches, for example, 4.75 to 6 inches, 5 to 5.75, or 5 to 5.5 inches. The total height is measured at the tallest height of the pillow 502 with the pillow 502 laying on a flat surface. Generally, all dimensions disclosed herein are measured at the most extreme point of the dimension if not otherwise stated.

The pillow 502 can include a compartment 514 extending through the pillow 502 along the major axis 506. The multi-density cervical spine support 504 can be disposed inside the compartment 514 and can be rotated inside the compartment 514 by way of a knob (not pictured) attached to an end of the multi-density cervical spine support 504. The multi-density cervical spine support 504 comprises a plurality of segments 516, 518, 520 each having a different density. The multi-density segments 516, 518, 520 can also be of varying hardness. For example, a first segment differs by at least 10% in hardness from a second segment, and the second segment differs by at least 10% from a third segment. The recited differences in hardness may be from 10% to 1000%, such as 20% to 500%, 100% to 300%. In an embodiment, the ILD of the segments of material 516, 518, 520, may be from 8 to 100, for example, 12 to 70, or 20 to 60.

The segments 516, 518, 520 can be joined at their respective interfaces such that the multi-density cervical spine support 504 has a cylindrical shape. For example, the segment 516 can be joined to the segment 518 at an interface 522, the segment 518 can be joined to the segment 520 at an interface 524, and the segment 520 can be joined to the segment 516 at an interface 526. The segments 516, 518, 520 can be joined at the interfaces 522, 524, 526 by suitable adhesives capable of durably adhering the segments 516, 518, 520. These adhesives may be the same or different based on the chemical properties of the material being joined.

The exemplary pillow 502 further comprises a head well portion 528 that makes up at least a part of the upper section 510. In some embodiments, the head well portion 528 can make up at least a part of each of the upper section 510 and the lower section 508. The head well 528 comprises supporting surfaces 530 separated by a plurality of grooves 532. The supporting surfaces 530 can comprise a material having a density and/or a hardness that differs from a density or hardness of either or both of the lower and upper sections 508-510 of the pillow 502. The grooves 532 may function to allow airflow through the head well 528, and other parts of the pillow 502, which can keep a user of the pillow 502 cool. The lower section 508 of the pillow 502 can also have grooves 534 along the lower surface 509 of the pillow 502 in order to promote airflow over the lower surface 509. In exemplary embodiments, the head well 528 can have a height between an upper surface 536 of the support portion 528 and a lower surface 538 of the head well 528 of 0.8 to 2.7 inches, 1 to 2.5 inches, 1.25 to 2.25 inches, or 1.4 to 2 inches. The upper surface 511 of the pillow 502 includes the upper surface 536 of the head well portion 528.

The head well portion 528 is configured for a user's head and neck to rest in the supine position, with the back of the head resting against the upper surface 536 of the head well portion 528 with the neck resting over the multi-density cervical spine support 504. In another use, a user can rest the head and neck on the upper portion 510 of the pillow 502, with the neck, resting over the multi-density cervical spine support 504 and the side of the head resting against the upper surface 511 of the pillow 502. In still another use, a user can turn the pillow 502 over, and the lower surface 509 of the pillow 502 is configured for a user's head and neck to rest in the side-lying position with the neck resting over the multi-density cervical spine support 504.

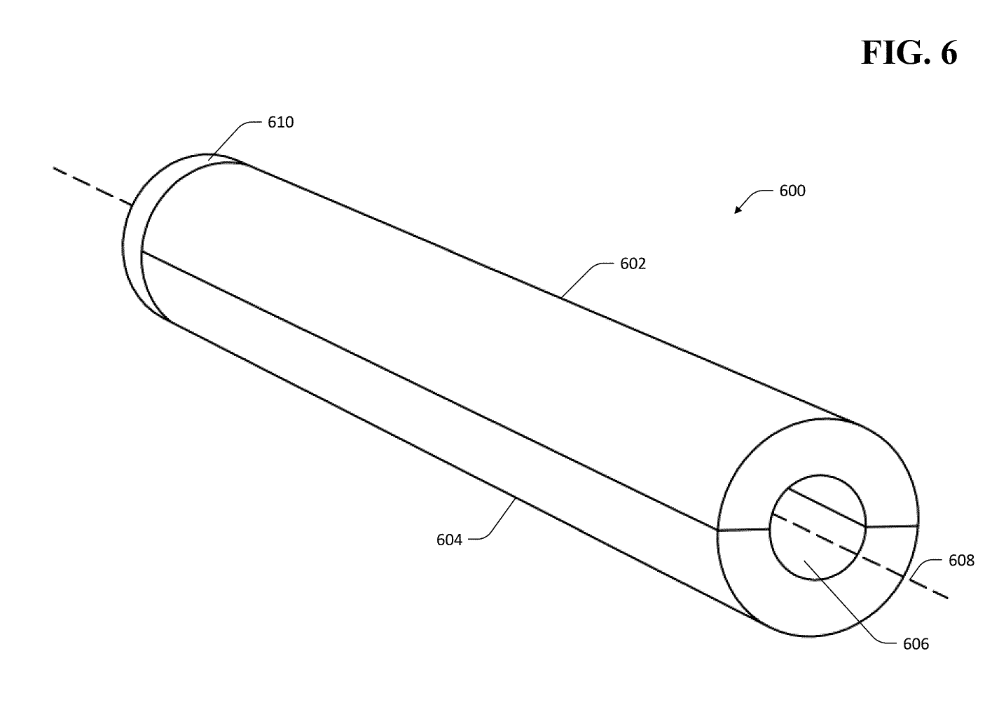

Referring now to FIG. 6, another exemplary embodiment of an adjustable cervical spine support structure 600 is illustrated. The adjustable cervical spine support 600 comprises a first portion 602 and a second portion 604. The first portion comprises a first material having a first density. The second portion 604 comprises a second material having a second density. The first portion 602 and the second portion 604 are joined such that a hollow cylindrical interior region 606 is formed that extends along a major axis 608 running through the adjustable cervical spine support 600. An end cap 610 (or knob) is connected to the terminal end of the adjustable cervical spine support structure 600. The opposite end of the adjustable cervical spine support 600 may also be connected to an end cap (not shown). The interface of the first 602 and second portion 604 and the end cap 610 may be joined together as disclosed in the prior embodiments. In an embodiment, the adjustable cervical spine support 600 is included in the adjustable pillow disclosed above instead of the adjustable cervical spine support 106 of FIGS. 2 and 4, or the multi-density cervical spine support 504 of FIG. 5.

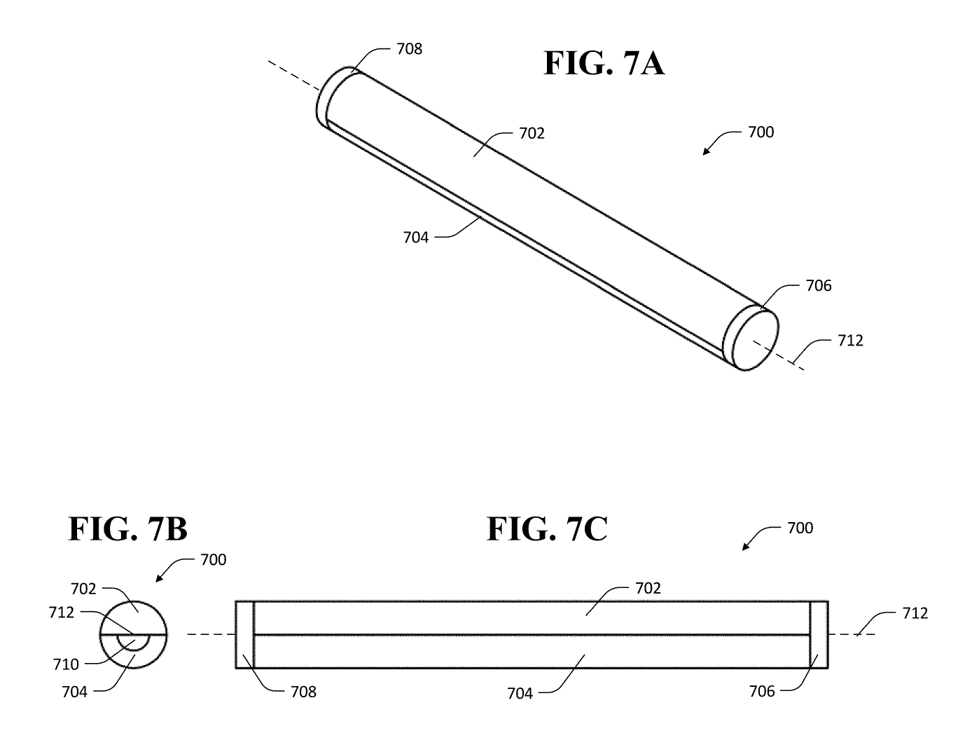

Referring now to FIGS. 7A-7C, still another exemplary embodiment of an adjustable cervical spine support structure 700 is illustrated. Referring to FIG. 7A, a perspective view of the adjustable cervical spine support 700 is shown. The adjustable cervical spine support 700 comprises a first portion 702 and a second portion 704 joined to form a substantially cylindrical shape. As in other embodiments described herein, the first portion 702 can comprise a first material having a first density, and the second portion 704 can comprise a second material having a second density. In an embodiment, the ILD of the first and second portions 702, 704 may be 8 to 100, for example, 12 to 70, or 20 to 60. In an exemplary embodiment, the second portion 704 can comprise a softer material than the first portion 702. For example, the first portion 702 can comprise a first type of foam having an ILD of 45 and the second portion 704 can comprise a second type of foam having an ILD of 17. An end cap 706 (or knob) is connected to the terminal end of the adjustable cervical spine support 700. The opposite end of the adjustable cervical spine support 700 is also be connected to an end cap 708.

Referring to FIG. 7B, a view facing one of the terminal ends of the adjustable cervical spine support 700 is shown, wherein the end cap 706 or 708 is removed. The second portion 704 of the adjustable cervical spine support 700 has a cut-out 710 running along a major axis 712 of the adjustable cervical spine support 700. Thus, when the first portion 702 and the second portion 704 are joined, a compartment with a half cylinder hollow opening is formed that runs along the length of the adjustable cervical spine support 700 parallel to the major axis 712. The cut-out 710 may also be of different geometries and produce different hollow openings when the first and second portions 702, 704 are joined. The cut-out 710 aids in adjustability of a pillow that incorporates the adjustable cervical spine support 700. The firmness of the adjustable cervical spine support 700 depends upon both the densities of the materials comprising the first and second portions 702 and 704, and an orientation of the cut-out 710 with respect to a force applied to the adjustable cervical spine support 700 (e.g., caused by the weight of a user's head resting on a pillow incorporating the adjustable cervical spine support 700). In some embodiments, the first portion 702 and the second portion 704 comprise the same material having the same density, and the variation in firmness of the adjustable cervical spine support 700 depends entirely upon the orientation of the cut-out 710 with respect to the force applied to the adjustable cervical spine support 700. Referring to FIG. 7C, a side view of the adjustable cervical spine support 700 is illustrated.

In an embodiment, the adjustable cervical spine support structure 700 may comprise a functional component that may be inserted into the first portion 702 and the second portion 704, such as in a cut-out 710 of the cervical spine support structure 700. The functional component provides additional functionality to a pillow that incorporates the adjustable cervical spine support structure 700. In an embodiment, the cut-out 710 may be enlarged and extended into both the first and second portions 702, 704 of the cervical spine support structure 700 so that additional room is available for embedding the functional component.

In one embodiment, the adjustable cervical spine support structure 700 includes a motor coupled to at least one massage node. The motor can cause the one or more massage nodes to rotate or vibrate, thus providing a massage to a user's neck. The motor may be battery powered, wherein the battery or batteries are also embedded in the cervical spine support structure 700.

In another embodiment, the adjustable cervical spine support structure 700 can further comprise a porous or vented compartment embedded or attached therein. The porous or vented compartment can receive a fragrant material. For example, the fragrant material can be an infusion, a carrier oil, a volatilized raw herb, an essential oil, an absolute (aromatic plant extract), an herbal distillate, a phytoncide, or combinations thereof. The fragrant material can emit an odor through the porous or vented compartment, thus providing a user with a therapeutic olfactory experience. The pores or vents on the compartment can be on the end of cervical spine support structure 700 and/or the outer cylindrical surface. The pillow may also have vents from the porous or vented compartment to the exterior of the pillow.

In another embodiment, the adjustable cervical spine support structure 700 can further comprise a speaker embedded or attached therein. The speaker can be configured to emit sounds conducive to user relaxation and/or to receive input from a mobile device.

In a fourth embodiment, the adjustable cervical spine support structure 700 can be outfitted with a compartment. The compartment can receive a hot or cold source. For example, the compartment can receive a heat pack to provide the user with a heating effect. The heat pack can increase a temperature of the adjustable cervical spine support, thus providing the cervical spine of a user with a warming effect. The heating element, for example, can be based on a reversible or irreversible exothermic chemical reaction, it can be a microwavable substance, or simply a compartment for hot tap water. Alternatively, battery and/or corded electric sources may power the heating element. The compartment can also receive a chilled cold source (e.g., an ice pack, a liquid pack, or a gel pack). The cold source can be recharged, for example, by placing it in a freezer. The cold source functions to decrease a temperature of the adjustable cervical spine support, thus providing the cervical spine of a user with a cooling effect. It may be preferable in such embodiments (either hot or cold) to select a material for the first and/or second portions 702, 704, and/or the pillow 502 that conducts temperature well, and/or has a decreased thickness.

In an embodiment, any of the functional components listed above can be directly inserted into the cylindrical compartment of the pillow In another embodiment, the functional component can be inserted into a cylindrical housing with a soft outer shell made of any of the previously disclosed materials.

The cervical spine support 700 may be made by shaping a first segment from a first sheet made of a first material and a second segment from a second sheet made of a second material. The first segment and the second segment (as well as an optional additional segment) are then coupled to form a cylinder. The first segment and the second segment are then coupled to form a cylinder. The second segment may be a different geometry than the first segment. For example, by varying the thickness of the segment, the firmness of the segment can be varied. The second segment, may, for example, have 10% to 1000% of the thickness of the first segment, such as 50% to 300%, or 75% to 150%. In an embodiment, a knob is attached to an end of the cervical spine support. The cervical spine support may be cylindrical and may have a length of 20 to 28 inches and a diameter of 3 to 6 inches. The cervical spine support may then be inserted into the previously described pillow. In an embodiment, the cervical spine support 700 can be molded, extruded, or otherwise formed as a single unit. This is particularly applicable to embodiments that only use one material for the cervical spine support 700.

The teachings recited herein are not limited to just pillows, but could also be employed in other types of cushions or cushion-containing furniture, such as chairs, seats used in transportation, mattresses, and hospital furniture.

In an embodiment, the adjustable cervical spine support 106 may be used outside the pillow 100, by itself, for example, as an aid for exercise or for massage. In an embodiment, the multi-density segments 204, 206, 208 may be separated in a plane perpendicular to the major axis 104, in particular, the separation may correspond to the area where flexible joints of the universal joint armature 212 are. In addition, in an embodiment, the multi-density segments 204, 206, 208 may be rotatable rather than fixed in relation to the universal joint armature 212, that is, the segments 204, 206, 208 may be joined to each other and rotate as a whole around the universal joint armature 212.

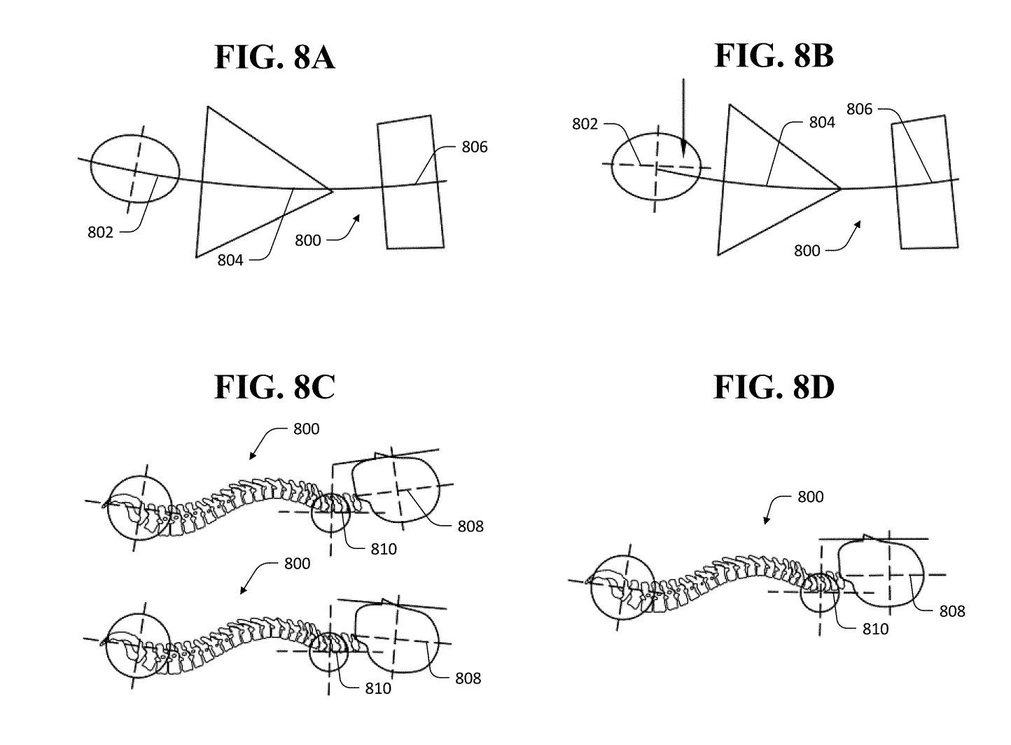

Referring now to FIGS. 8A-8D, diagrams showing exemplary alignments and misalignments of a spine of a human subject are illustrated. FIG. 8A shows an alignment of a person's spine 800 in a side-lying position wherein a continuous spline is formed by cervical 802, thoracic 804, and lumbar 806 sections of the spine 800. FIG. 8B illustrates a misalignment of the cervical section 802 of the spine 800 wherein a continuous spline running through the thoracic section 804 and the lumbar section 806 is misaligned with the cervical section 802. FIG. 8C illustrates a misalignment of head 808 and neck 810 sections of the spine 800 of the subject in a supine position in both flexion and hyperextension. FIG. 8D illustrates alignment of the head 808 and neck 810 sections of the spine 800 in the supine position, wherein the sections 808-810 are shown aligned with parallel horizontal planes. These exemplary alignment and misalignment guidelines were used to determine the various measurements in Tables 1 and 2, below.

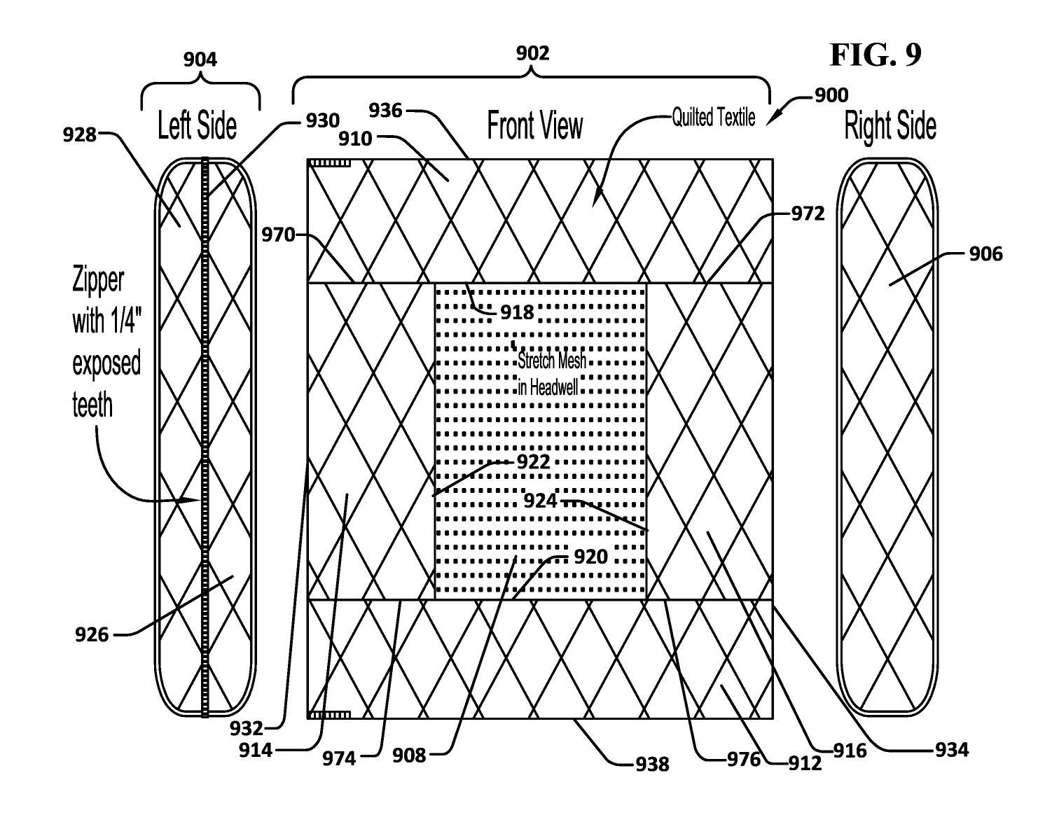

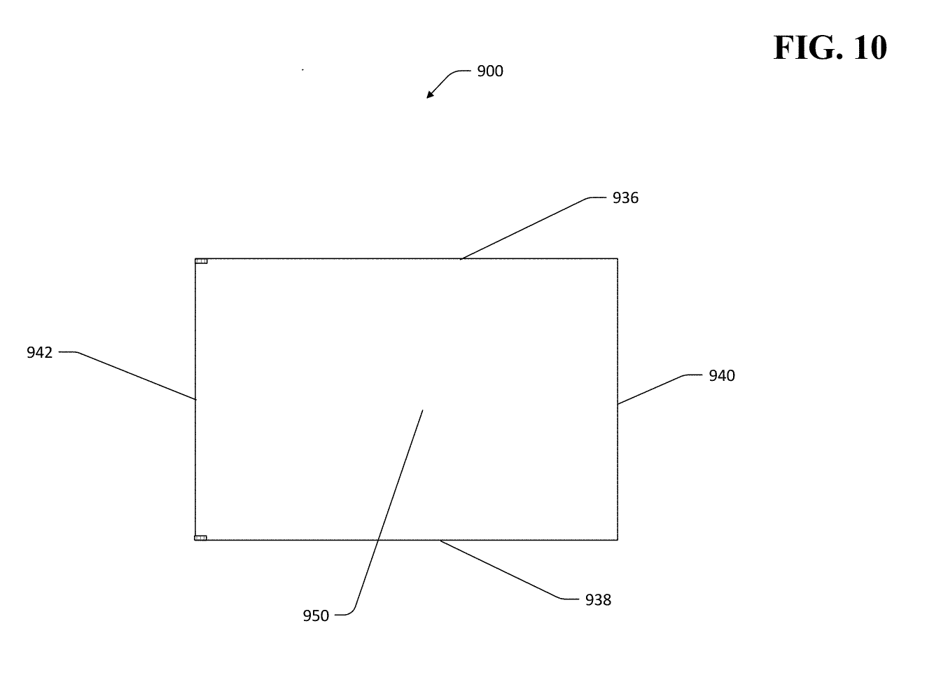

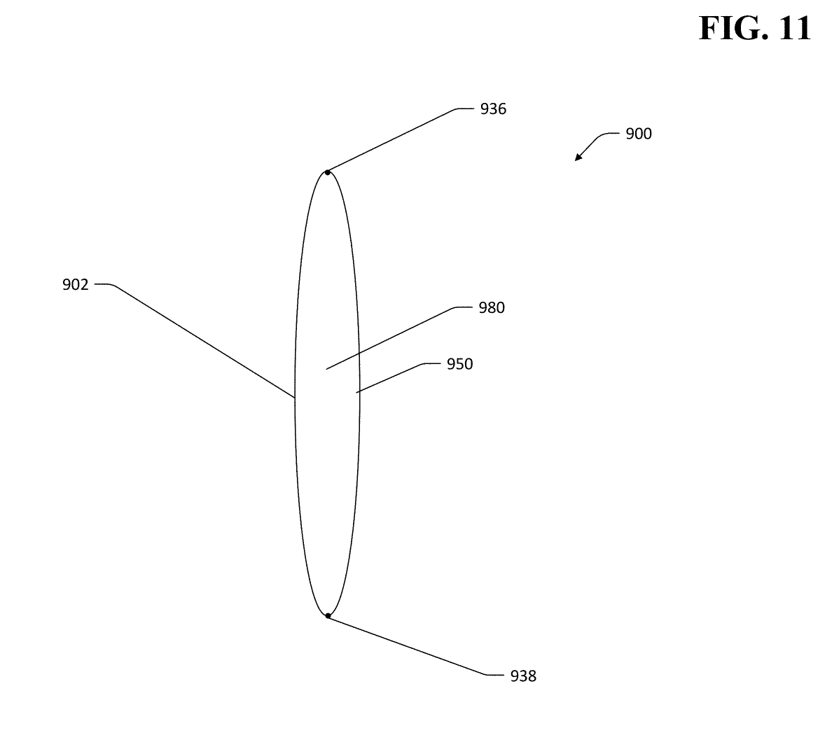

Turning now to FIG. 9, an example pillow case 900 with a central region 908 made of a single layer of a 4-way stretch material designed to be used with a pillow including a head well is illustrated. The pillow case 900 defines a hollow cavity 980 (see FIG. 11) in which a pillow featuring a head well can be disposed. The central region 908 of the pillow case 900 can be made of a 4-way stretch material, whereas the remaining components of the pillow case 900 are substantially made of a non-stretchable material, such as a quilted textile. In an embodiment, the non-stretchable material may be porous. Generally speaking, the pillow case can be defined by four portions: a front portion 902 including the central region 908, a back portion 950 (see FIG. 10), a first side portion 904 configured with an opening and a fastener designed to receive a pillow, and a second side portion 906. The four portions of the pillow case can be attached perimetrically (i.e., joined to each other at their perimeters) to define the hollow cavity 980 (see FIG. 11) in which a pillow with a head well can be disposed therein.

In an embodiment, the front portion 902 of the pillow case 900 comprises the central region 908, as well as a non-central region comprising a front-top panel 910, a front-bottom panel 912, a front-left panel 914, and a front-right panel 916. The front-top panel 910, the front-bottom panel 912, the front-left panel 914, and the front-right panel 916 can be made of a non-stretchable material, whereas the central region 908 can be made of a single layer of a 4-way stretch material.

The central region 908 of the pillow case 900 is located in the central area of the front portion 902 of the pillow case 900 and is configured to rest over a head well and stretch to make contact with a head well of a pillow when a user's head is laying thereon. In an embodiment where a head well of a pillow has a lower surface with a depth of 0.8 to 2.7 inches from a top surface of the pillow, the central region 908 can be designed to stretch to a depth of 1.0 to 3.5 inches from a top surface of the pillow when pressure is applied thereto. For example, the central region 908 can stretch to a depth of 1.2 to 2.2 inches, 0.9 to 1.5 inches, or 2.1 to 2.6 inches from a top surface of the pillow when pressure is applied thereto. Additionally, the elasticity of the central region 908 can be measured by a stretch test as described in ASTM D3107-1980 “Standard test method for stretch properties of fabrics woven from stretch yarns.” A sample size of 51 mm by 500 mm stretch material (e.g., the central region 908) is attached to two clamps, a top clamp and a bottom clamp. A 1.8 kg weight hangs from the bottom clamp. The original distance between the top and bottom of the sample stretch material is measured as “A”. The sample is then stretched by cycling from 0 to 1.8 kg load with a 5 second interval. The 1.8 kg load is then applied a fourth time and the extension “B” is measured. The fabric stretch percent is calculated as follows:

$$Fabric stretch percent = \frac{B - A}{A} * 100 \%$$

Under the ASTM D3107-1980 test, the fabric for the central region 908 can have a fabric stretch percent of 5.08 to 25%. For example, the central region 908 can have a fabric stretch percent of 6 to 20%, 8 to 14.5%, or 10 to 12%.

As stated previously, the central region 908 can be made of a 4-way stretch material. For example, the 4-way stretch material can be a mesh knit, spandex, vinyl, velvet, denim, cotton, or polyester.

The central region 908 can be rectangular and can have a length of 8 inches to 12 inches and a width of 6 to 10 inches. For example, the central region 908 can have a length of 9 to 11 inches, 8.5 to 10 inches, or 10.5 to 11.5 inches and a width of 7 to 9 inches, 6.5 to 8 inches, or 8.5 to 9.5 inches.

The front-top panel 910 and the front-bottom panel 912 can define a length of the pillow case 900, respectively. Additionally, the front-bottom panel 912 can be designed to be adjacent to a cervical spine support disposed in a pillow. The front-top panel 910 and the front-bottom panel 912 can have a length of 22 to 26 inches and a width that of 3 to 6 inches. For example, the lengths of the front-top panel 910 and the front-bottom panel 912 can be 22.5 to 26 inches, 23.5 to 25 inches, or 24 to 25.5 inches and the widths of the front-top panel 110 and the front-bottom panel 912 can be 4.7 to 5.8 inches, 3.5 to 4.5 inches, or 4.2 to 5 inches. The front-top panel 910 and the front-bottom panel 912 can be made of a non-stretchable material. In an embodiment, the front-top panel 910 and the front bottom panel 912 can be made of quilted textile. In other embodiments, the front-top panel 910 and the front bottom panel 912 can be made of cotton, polyester, rayon, spandex, or blends thereof.

The front-left panel 914 and the front-right panel 916 (along with the widths of the front-top panel 910 and the front-bottom panel 912) can define a width of the pillow case 900. Lengths of the front-left panel 914 and the front-right panel 916 can be 9 to 13 inches and widths of the front-left panel 914 and the front-right panel 916 can be 5 to 8 inches. For example, the lengths of the front-left panel 914 and the front-right panel 916 can be 11 to 12.8 inches, 10 to 11.5 inches, or 9.4 to 10.6 inches and the widths of the front-left panel 914 and the front-right panel 916 can be 6.3 to 7.5 inches, 5.2 to 6.2 inches, or 6 to 7 inches.

The front-top panel 910, the front-bottom panel 912, the front left panel 914, and the front right panel 916 can be attached to the central region 908 by interfaces 918, 920, 922, 924, respectively. Additionally, the front-top panel 910 can be attached to the front-left panel 914 and the front-right panel 916 by interfaces 970 and 972, respectively, and the front-bottom panel 912 can be attached to the front-left panel 914 and the front-right panel 916 by interfaces 974 and 976, respectively. In an embodiment, the attachment of the aforementioned portions and regions can be accomplished through sewing.

The back portion 950 (see FIG. 10) of the pillow case 900 can be made of a non-stretchable material, such as a quilted textile. Unlike the front portion 902, the back portion 950 can comprise a single panel. The back portion 950 can conform to the dimensions of the front portion 902 as detailed above, that is, a length of the back portion 950 can be 22 to 26 inches and a width of the back portion 950 can be 13 to 18 inches. For example, the length of the back portion 950 can be 23 to 25 inches, 22.5 to 24 inches, or 24.5 to 25.5 inches and the width of the back portion 950 can be 14.5 to 17 inches, 13.5 to 15.5 inches, or 16.5 to 17.8 inches. The back portion 950 can be attached to the front-top panel 910 at an interface 936 and to the front-bottom panel 912 at an interface 938. In an embodiment, attachment can be accomplished through sewing.

The first side portion 904 can comprise a first panel 926 and a second panel 928 attached by a releasable fastener 930. In an embodiment, the releasable fastener 930 can be a zipper. An edge of the first panel 926 not including the releasable fastener 928 can be attached to the front portion 902 of the pillow case 900 at an interface 932. The interface 932 can be defined by the left edges of the front-top panel 910, the front-left panel 914, and the front-bottom panel 912. An edge of the second panel 928 not including the releasable fastener 930 can be attached to the back portion 950 (not shown) of the pillow case 900 at an interface 942. In an embodiment, attachment can be accomplished through sewing. The releasable fastener 930 may be un-fastened to allow a pillow with a head well to be inserted into the hollow cavity 980 and fastened to secure the pillow therein. The first panel 926 and the second panel 928 can have a length of 13 to 18 inches and a width of 1.5 to 3.5 inches. For example, the first panel 926 and the second panel 928 can have a length of 14 to 16 inches, 13.5 to 15 inches, or 15.5 to 17 inches and a width of 2.75 to 3.4, 2 to 3.25 inches, or 1.75 to 2.25 inches.

A section of the perimeter of the second side portion 906 can be attached to the front portion 902 at an interface 934 and to the bottom portion 950 at an interface 940. In an embodiment, attachment can be accomplished through sewing. The second side portion 906 can provide a surface to help secure a pillow disposed in the hollow cavity 980 (not shown). The second side portion 906 can have a length of 13 to 18 inches and a width of 3 to 7 inches. For example, the second side portion 906 can have a length of 15.5 to 18 inches, 14 to 16 inches, or 13.5 to 15 inches and a width of 3.5 to 7 inches, 4 to 6.5 inches, or 5.2 inches to 6.8 inches. The second side portion 906 can be made of a non-stretchable material, such as a quilted textile.

In an embodiment, the releasable fastener 930 may also extend onto the outer perimeter of the front-top panel 910 and the front-bottom panel 912 (and their corresponding perimeters in the back portion 950) in a distance of 1 to 3 inches. For example, the distance extended may be 1.2 to 3 inches, 2.1 to 2.8 inches, or 1.8 to 2.4 inches. Extending the releasable fastener to the front-top panel 910 and front-bottom panel 912 can reduce the difficult in inserting a pillow into the pillow case 100 by providing a wider opening into the hollow cavity 980 (see FIG. 11).

The first side portion 904 and the second side portion 906 of the pillow case 900 may be adorned with piping sewn across the interfaces 932, 942, 934, 940, so as to provide an aesthetically pleasing appearance to the pillow case 900. The diameter of the piping can be 0.1 to 0.16 inches. For example, the diameter of the piping can be 0.11 to 0.13 inches, 0.12 to 0.14 inches, or 0.13 to 0.15 inches. As discussed above, the first side portion 904 and second side portion 906 can be made of a non-stretchable material, for example, a quilted textile. It is understood that in a different embodiment the pillow case 900 can have the first side portion 904 and the second side portion 906 reversed such that a pillow case can be inserted into the right side of the pillow case 900 instead of the left side.

In an embodiment, the pillow case 900 is open or has an open portion on both ends. This is to accommodate the knob of the example pillow described in FIG. 5 and the accompanying text above. The open portion may run the entire length of the sides of the pillow case 900 or may be open only at one end portion so that it is configured to match up with the knob of the example pillow of FIG. 5. In an embodiment, the fastener only runs along the portion of the pillow that is not open for access to the knob.

While the pillow case 900 is depicted as being substantially rectangular, it is understood that the pillow case may also be configured for different pillow geometries. For example, in a different embodiment for a pillow that is a substantially circular pillow, the pillow case 900 can be circular. Although the pillow case 900 is depicted as comprising a front portion, back portion, and two side portions, it is understood that in different embodiments the pillow case can comprise only a front portion and back portion. Additionally, the central region 908 of the pillow case 900 may be configured in shapes other than the rectangle depicted in FIG. 9. For example, the central region 908 may be square, circular, and/or ovular depending on the particular embodiment. The pillow case 900 may also be adorned with different colors and/or patterns so as to provide a more aesthetically pleasing appearance to a user. In an example, the pillow case 900 can be colored to match the rest of the user's bedding.

FIG. 10 shows the back portion 950 of the pillow case 900. The back portion 950 can be attached to the front-top panel 910 at an interface 936 and to the front-bottom panel 912 at an interface 938. As noted above, the back portion 950 can be made of a non-stretchable material, such as a quilted textile. In certain embodiments, the releasable fastener 930 may extend onto a segment of the back portion 950.

FIG. 11 shows a cross-sectional view of the front portion 902 and the back portion 950 of the pillow case 900 (with the first side portion 904 and the second side portion 906 removed). The front-top panel 910 of the front portion 902 is attached to the back portion 950 at the interface 936. The front-bottom panel 912 of the front portion 902 is attached to the back portion 950 at the interface 938. The hollow cavity 980 is designed to receive a pillow.

Exemplary operation of the pillow/cervical spine support/pillow case system is now set forth. The pillow 502 with a head well portion 528 is disposed inside the hollow cavity 980 of the pillow case 900 such that the central region 908 is next to the head well portion 528, but not touching the lower surface 538 of the head well 528. It is further contemplated that the multi-density cervical spine support 504 is disposed in a compartment 514 of the pillow 502. When a user's head is not resting on the central region 908, the central region 908 is substantially coplanar with the front-top panel 910, the front-bottom panel 912, the front-left panel 914, and the front-right panel 916. The user may rest on the pillow/pillow case such that his/her neck rests over the multi-density cervical spine support 504 (which is covered by the front-bottom panel 912 of the pillow case 900) and his/her head rests on the central region 908. The central region 908 stretches to accommodate the user's head such that the central region 908 makes contact with the lower surface 538 of the head well 528 and can further sink into the soft material of the head well 528. The central region 908 can thus stretch towards the head well 528 in a distance of 1.0 to 3.5 inches. For example, the central region 908 can stretch towards the head well 528 in a distance of 1.2 to 3.0 inches, from 1.25 to 2.25 inches, or from 1.4 to 2 inches. As the central region 908 is now in contact with the head well 928, the user can fully realize the benefits of the pillow 502 while retaining the hygienic, tactile, and aesthetic benefits of a pillow case.

### EXAMPLES

Provided below in Tables 1 and 2 are exemplary data relating to effects of various pillow design parameters on alignment of subjects' cervical spines in connection with using a pillow constructed in accordance with embodiments of the present disclosure. The data include, for each test subject, a shoulder width, hip width, and a difference between the shoulder width and the hip width (labeled “Physiological Differential”). The data also include, for each subject, a height of the highest point of the subject's head when lying on a test bed frame with the subject's spine in alignment (labeled “Alignment Height”). This “alignment height” was determined in accordance with FIG. 8A by a neck and spine specialist from visual assessments of the test subjects. Then a height of the highest point of the subject's head was determined when lying on the test bed frame with the subject's head resting on a first prototype pillow having a total height of approximately 6 inches and a head well depth of approximately 1 inch (labeled “Prototype 1”). All data in Tables 1 and 2 are in units of inches unless otherwise noted.

The data further include a difference in height of the subject's head between the alignment height and the height for each of a variety of prototype pillows. In the side-lying position (Table 1) the subjects rested their head and neck on the lower surface 535, (i.e., the head-well portion was facing the mattress) of a pillow constructed similarly to pillow 502. The data show the difference in height when the subject's head is resting on the first pillow prototype having a height of 6 inches (labeled “Alignment Height Differential”), the difference in height when the subject's head is resting on a second pillow prototype having height of 5.5 inches (labeled “Differential (Prototype 2)”), and the difference in height when the subject's head is resting on a third pillow prototype having height of 5.25 inches (labeled “Differential (Prototype 3)”). Thus, the smaller the absolute value of the number for the “Differential” data points the closer the subject was to being in correct alignment.

In the supine position (Table 2), the subjects rested their head and neck on the upper section 510 and head well 528 of a pillow constructed similarly to pillow 502. The data include the difference in height when the subject's head is resting on the first pillow prototype having height of 6 inches and head well depth of 1 inch (labeled “Alignment Height Differential”), the difference in height when the subject's head is resting on a fourth pillow prototype having height of 5.5 inches and head well depth of 2 inches (labelled “Differential (Prototype 4)”), and the difference in height when the subject's head is resting on a fifth pillow prototype having height of 5.25 inches and head well depth of 2 inches (labeled “Differential (Prototype 5)”).

TABLE 1
Side-lying position:

| | | | | | | | Alignment | Differential | Differential |
|---|---|---|---|---|---|---|---|---|---|
| | | Shoulder | Hip | Physiological | Alignment | Prototype | Height | (Prototype | (Prototype |
| | Gender | Width | Width | Differential | Height | 1 | Differential | 2) | 3) |
| GP | M | 17.75 | 14 | 3.75 | 28.75 | 28.75 | 0 | −0.5 | −0.75 |
| MT | M | 17.75 | 14.5 | 3.25 | 29 | 28.875 | −0.125 | −0.625 | −0.875 |
| AD | M | 18 | 13.75 | 4.25 | 28 | 28.75 | 0.75 | 0.25 | 0 |
| RP | M | 20.5 | 14.25 | 6.25 | 28.125 | 28.5 | 0.375 | −0.125 | −0.375 |
| TS | F | 15.5 | 13.5 | 2 | 27 | 29 | 2 | 1.5 | 1.25 |
| SH | M | 16.5 | 13 | 3.5 | 28.25 | 28.875 | 0.625 | 0.125 | −0.125 |
| JC | M | 17 | 13.5 | 3.5 | 27.25 | 28.875 | 1.625 | 1.125 | 0.875 |
| BP | F | 15.875 | 14.5 | 1.375 | 27.875 | 29.125 | 1.25 | 0.75 | 0.5 |
| KM | F | 19 | 18 | 1 | 27.625 | 28.625 | 1 | 0.5 | 0.25 |
| GALA | F | 17.125 | 17.125 | 0 | 27.75 | 29 | 1.25 | 0.75 | 0.5 |
| BJ | F | 18.75 | 16 | 2.75 | 28.25 | 29.25 | 1 | 0.5 | 0.25 |
| VM | F | 16.75 | 13.75 | 3 | 27.75 | 28.75 | 1 | 0.5 | 0.25 |
| KH | F | 18.75 | 16.25 | 2.5 | 28.375 | 28.625 | 0.25 | −0.25 | −0.5 |
| LH | F | 14.375 | 13.75 | 0.625 | 28.125 | 29 | 0.875 | 0.375 | 0.125 |
| MM | F | 18.75 | 15 | 3.75 | 29.5 | 29.75 | 0.25 | −0.25 | −0.5 |
| SMS | F | 16.25 | 14.75 | 1.5 | 28 | 29.5 | 1.5 | 1 | 0.75 |
| SLS | F | 16 | 12.5 | 3.5 | 28.5 | 29.125 | 0.625 | 0.125 | −0.125 |
| KS | F | 17.75 | 15 | 2.75 | 27.875 | 28.875 | 1 | 0.5 | 0.25 |
| MA | F | 16 | 12.5 | 2.5 | 27.75 | 28.875 | 1.125 | 0.625 | 0.375 |
| JS | M | 19.25 | 13.125 | 6.125 | 28.125 | 29 | 0.875 | 0.375 | 0.125 |

TABLE 2
Supine position:

| | | | | | | | Alignment | Differential | Differential |
|---|---|---|---|---|---|---|---|---|---|
| | | Shoulder | Hip | Physiological | Alignment | Prototype | Height | (Prototype | (Prototype |
| | Gender | Width | Width | Differential | Height | 1 | Differential | 4) | 5) |
| GP | M | 17.75 | 14 | 3.75 | 27.875 | 30 | 2.125 | 0.625 | 0.375 |
| MT | M | 17.75 | 14.5 | 3.25 | 27.875 | 29.625 | 1.75 | 0.25 | 0 |
| AD | M | 18 | 13.75 | 4.25 | 27.375 | 29 | 1.625 | 0.125 | −0.125 |
| RP | M | 20.5 | 14.25 | 6.25 | | | | | |
| TS | F | 15.5 | 13.5 | 2 | | | | | |
| SH | M | 16.5 | 13 | 3.5 | | | | | |
| JC | M | 17 | 13.5 | 3.5 | | | | | |
| BP | F | 15.875 | 14.5 | 1.375 | 28 | 29.875 | 1.875 | 0.375 | 0.125 |
| KM | F | 19 | 18 | 1 | 28.25 | 30 | 1.75 | 0.25 | 0 |
| GALA | F | 17.125 | 17.125 | 0 | 27.25 | 29.875 | 2.625 | 1.125 | 0.875 |
| BJ | F | 18.75 | 16 | 2.75 | 27.75 | 29.375 | 1.625 | 0.125 | −0.125 |
| VM | F | 16.75 | 13.75 | 3 | 27.75 | 29.625 | 1.875 | 0.375 | 0.125 |
| KH | F | 18.75 | 16.25 | 2.5 | 27.875 | 29.5 | 1.625 | 0.125 | −0.125 |
| LH | F | 14.375 | 13.75 | 0.625 | 28.25 | 30.125 | 1.875 | 0.375 | 0.125 |
| MM | F | 18.75 | 15 | 3.75 | 28 | 29.625 | 1.625 | 0.125 | −0.125 |
| SMS | F | 16.25 | 14.75 | 1.5 | 27.875 | 29.875 | 2 | 0.5 | 0.25 |
| SLS | F | 16 | 12.5 | 3.5 | 27.5 | 29.625 | 2.125 | 0.625 | 0.375 |
| KS | F | 17.75 | 15 | 2.75 | 28.125 | 30 | 1.875 | 0.375 | 0.125 |
| MA | F | 16 | 13.5 | 2.5 | 28 | 29.5 | 1.5 | 0 | −0.25 |
| JS | M | 19.25 | 3.125 | 16.125 | 27.875 | 29.875 | 2 | 0.5 | 0.25 |

Through the study it was determined that the greatest number of subjects were closest to alignment when using prototype pillows 3 and 5.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A cervical spine support for insertion in a pillow comprising either:
(a) a first segment made of a first material having a first density and a second segment made of a second material having a second density or a geometry different from the first segment;
wherein the cervical spine support has a major axis and is configured to rotate around the major axis in relation to the pillow;
or
(b) a functional component selected from the group consisting of:
a speaker; a motor coupled to at least one massage node, the motor and the at least one massage node embedded in the cervical spine support, wherein the motor causes the at least one massage node to rotate or vibrate; a porous or vented compartment, wherein a fragrant material is disposed in the porous compartment; a heat source; a compartment filled with a gel or liquid, wherein the gel or the liquid is chilled.

2. The cervical spine support of claim 1, wherein the cervical spine support further comprises the speaker embedded therein.

3. The cervical spine support of claim 1, wherein the cervical spine support further comprises the motor coupled to the at least one massage node, the motor and the at least one massage node embedded in the cervical spine support, wherein the motor causes the at least one massage node to rotate or vibrate.

4. The cervical spine support of claim 1, wherein the cervical spine support further comprises the porous or vented compartment, wherein the fragrant material is disposed in the porous compartment.

5. The cervical spine support of claim 1, wherein a length of the cervical spine support is 20 to 28 inches.

6. The cervical spine support of claim 1, wherein the cervical spine support is cylindrical and the cervical spine support has a diameter of 3 to 6 inches.

7. The cervical spine support of claim 1, wherein the cervical spine support further comprises a compartment, wherein a heat source is disposed in the compartment.

8. The cervical spine support of claim 1, wherein the cervical spine support further comprises a compartment, wherein a pack filled with a gel or liquid is disposed in the compartment, wherein the gel or the liquid is chilled.

9. A system comprising:
a pillow comprising:
a head well portion having a lower surface with a depth of 0.8 to 2.7 inches from a top surface of the pillow; and
a hollow compartment,
wherein the pillow has a total thickness of 5 to 6.25 inches from a top surface of the pillow to a bottom surface of the pillow; and
a cervical spine support running along a major axis of the pillow disposed in the hollow compartment, the cervical spine support comprising either:
(a) a first segment made of a first material having a first density and a second segment made of a second material having a second density or a geometry different from the first segment;
wherein the cervical spine support is configured to rotate around the major axis in relation to the pillow;
or
(b) a functional component selected from the group consisting of:
a speaker; a motor coupled to at least one massage node, the motor and the at least one massage node embedded in the cervical spine support,
wherein the motor causes the at least one massage node to rotate or vibrate; a porous or vented compartment, wherein a fragrant material is disposed in the porous compartment; a heat source; a compartment filled with a gel or liquid, wherein the gel or the liquid is chilled.

10. The system of claim 9 further comprising:
a pillow case comprising:
a front portion comprising a central region and a non-central region; and
a back portion,
wherein the central region is made of a single layer of a 4-way stretch material and the non-central region and the back portion are made of a non-stretchable material, and the front portion and the back portion are attached perimetrically to define a hollow cavity, the pillow is disposed in the hollow cavity, and the central region of the pillow case is aligned with the head well portion of the pillow.

11. The system of claim 9, wherein a circumferential difference between the cervical spine support and a surface of the substantially hollow compartment is 1 μm to 1 cm.

12. The system of claim 9, wherein the second segment has a geometry different from the first segment.

13. The system of claim 9, wherein a length of the cervical spine support is 20 to 28 inches; and the cervical spine support is cylindrical and has a diameter of 3 to 6 inches.

14. A method of making a cervical spine support for a pillow, the method comprising:
shaping a first segment from a first material to form a section of a cylinder;
shaping a second segment from a second material or shaping the second segment to have a different geometry than the first segment, in either case, forming a second section of a cylinder;
coupling the first segment and the second segment, and optionally an additional segment to form a cylinder; and
attaching a knob to an end of the cervical spine support;
wherein a length of the cervical spine support is 20 to 28 inches; and the cervical spine support is cylindrical and has a diameter of 3 to 6 inches.

15. The method of claim 14, further comprising inserting the cervical spine support into a hollow compartment in the pillow.
